(19) United States
(12) Patent Application Publication
(10) Pub. No.: US 2005/0240554 A1
(43) Pub. Date: Oct. 27, 2005

(54) Data storage method and system

(76) Inventors: Chris Evans, Bristol (GB); Martin Hogg, Bristol (GB); Paul Harry, Bristol (GB)

Correspondence Address: Edward A. Pennington;Swidler Berlin Shereff Friedman, LLP, Suite 300, 3000 K Street, NW, Washington, DC, 20007-5116, US

(21) Appl. No.: 10/921,154

(22) Filed: Aug. 19, 2004

(30) Foreign Application Priority Data
Apr. 23, 2004 (GB) 0409125.2

(51) Int. Cl. G06F 7/00

(52) U.S. Cl. 707/1

(57) ABSTRACT

A data storage method is described which comprises receiving a store command issued by a user in respect of a data object, and in response: 1. ascertaining whether an auxiliary function is associated with the data object; 2. storing the data object; and 3. executing the auxiliary function ascertained in step (a) to be associated with the data object.

This invention relates to a data storage method and to a system adapted to perform that method.

Conventional file storage systems are ubiquitous; every desktop computer is provided with a system for the storage and retrieval of data files.

More complex file storage systems are available which can offer features such as inter-file dependency tracking. Such a system may be useful for storage of, for example, Java objects but there is an inherent disadvantage with this type of system since the files being stored using it, for example, the Java objects, must be adapted to conform to a standard required by the system. This is extremely inconvenient since each stored Java class must be modified to take account of the storage system. Furthermore, it is extremely inconvenient when the user does not wish to make use of the enhanced facilities of the system since he must nevertheless adapt the file to be stored such that it is compatible with the system.

In accordance with one aspect of the present invention there is provided a data storage method comprising receiving a store command issued by a user in respect of a data object, and in response:
a. ascertaining whether an auxiliary function is associated with the data object;
b. storing the data object; and
c. executing the auxiliary function ascertained in step (a) to be associated with the data object.

Hence, by ascertaining whether an auxiliary function, which may be used to implement dependency tracking or other enhanced features, is associated with the data object and executing such an associated auxiliary function, the invention provides a method whereby data objects can simply be stored if it is not desired to make use of the enhanced features or alternatively, the enhanced features may be implemented, if desired. The invention performs this function automatically thereby overcoming the problems with the prior art in which users were inconvenienced by being forced to modify data objects to conform with the enhanced data storage system even if they did not wish to make use of the enhanced facilities.

In one embodiment, the auxiliary function ascertains whether the data object is dependent upon one or more of the already stored data objects and constructs a dependency list that indicates any such dependencies.

In yet another embodiment, the auxiliary function establishes a unique identification code for the data object and stores this identification code either in the data object itself or in a separate identification code table.

In a second aspect of the invention, a data storage method comprises receiving a store command issued by a user in respect of a data object, and in response:
a. ascertaining whether an auxiliary function is associated with the data object;
b. if the auxiliary function is not associated with the data object, storing the data object; otherwise
c. executing the auxiliary function ascertained in step (a) to be associated with the data object and then storing the data object dependent on a result generated by the auxiliary function.

Thus, the invention also provides a method in which if there is no auxiliary function associated with the data object the data object is simply stored or alternatively, the auxiliary function is executed before any storage operation is performed and the data object is only stored dependent on a result generated by the auxiliary function.

The invention may be provided as a computer program comprising computer program code means adapted to perform the steps of the methods defined by the first and second aspects of the invention when said program is run on a computer.

Alternatively, the invention may be provided as a computer program product comprising program code means stored on a computer readable medium for performing the method of either of the two aspects of the invention when said program is run on a computer.

According to a third aspect of the invention, a data storage system comprises a store for storing data objects and a controller adapted to perform the method according to the first and second aspect of the invention and store the data objects in the store.

An embodiment of the invention will now be described with reference to the accompanying drawings, in which:

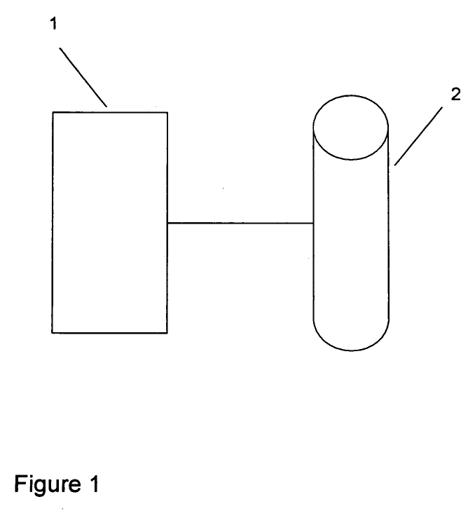

FIG. 1 shows a system adapted to perform the methods of the invention;

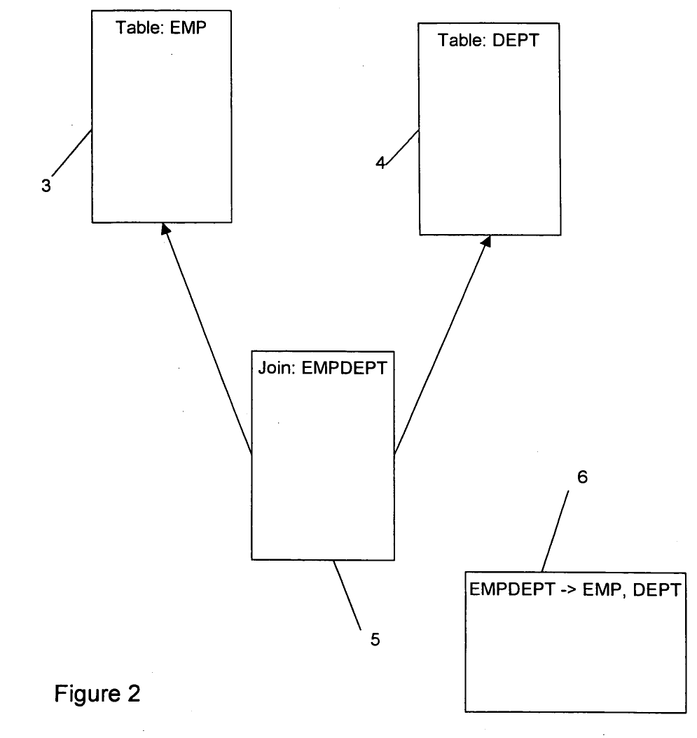

FIG. 2 shows Java objects representing two tables in a database and a join linking the tables;

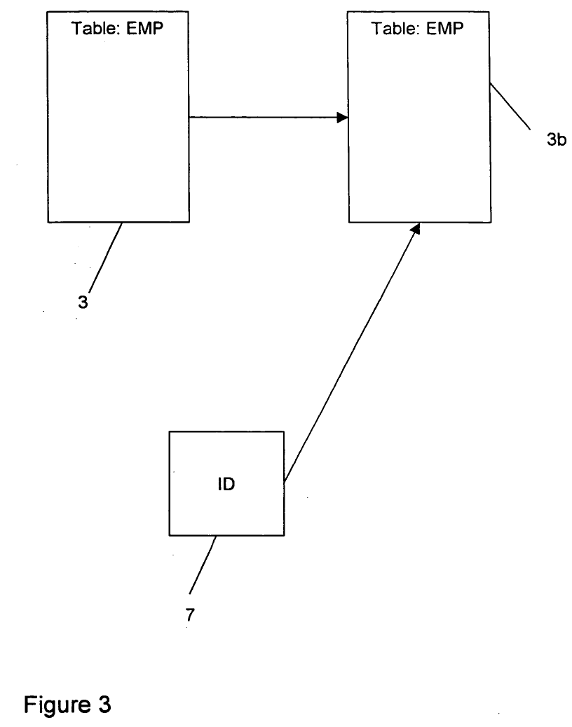

FIG. 3 shows a Java object representing a database table in which is stored a unique identification code; and

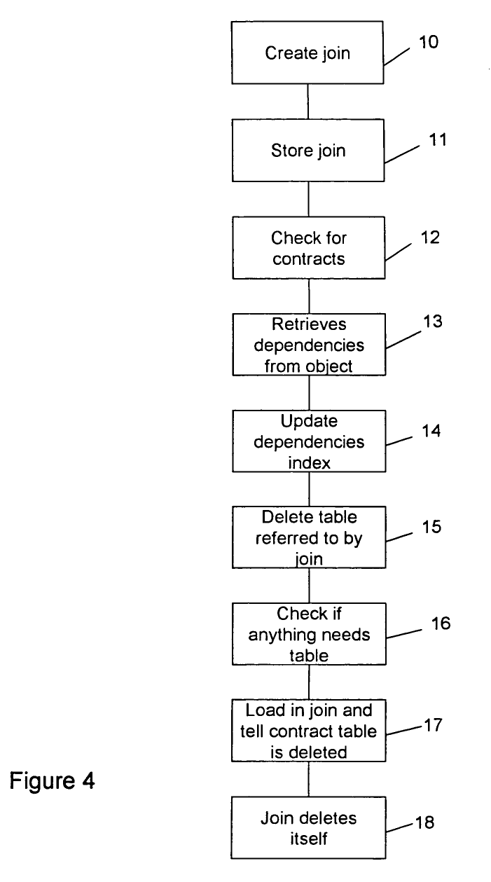

FIG. 4 shows an example flow chart for operation of the invention.

FIG. 1 shows a computer system suitable for performing the present invention. The computer 1 is connected to a file store 2, such as a hard disk drive or database storage system. A central processing unit within the computer 1 executes software that implements the methods of the invention. Such software may be part of the operating system of the computer or it may be separate application software.

The invention operates by inspecting a file to be saved before it is stored on the hard disk 2. The file may be a Java object or C# object or alternatively, it may be a document file such as a word document or PDF document. If, on inspection of the file to be saved it is ascertained that no auxiliary function is associated with the file then it is simply stored on the hard disk 2.

If, on the other hand, it is ascertained that an auxiliary function is associated with the file then the auxiliary function will be executed in addition to storing the objects. It is important to realise that, in many cases, it is unimportant whether the object is stored before or after execution of the auxiliary function and that, in some other cases, the data object may only be stored dependant on a result generated by the auxiliary function.

Some examples of possible auxiliary functions, or contracts as they are also known, will now be described to clarify the operation of the invention.

FIG. 2 shows an example of a dependency tracking contract. In this example, there are two Java objects 3,4 of class TABLE and one Java object 5 of class JOIN. The Java class JOIN in this example is adapted such that on scrutiny by the file storage software it becomes apparent to the file storage software that the class implements the dependency tracking contract.

Associated with this contract there is an auxiliary function that is included in the class and this function is operable to indicate to the file storage software which other data objects the Java object 5 depends upon. In this instance, it will indicate that it depends on objects 3 and 4.

The file storage software stores the objects and constructs a dependency list 6 which indicates that the join object 5 (known as EMPDEPT in this example) depends on the table objects 3 and 4 (in this instance, EMP and DEPT respectively).

There may be a further auxiliary function associated with the adapted JOIN class that is operated on deletion of either of the objects upon which object 5 is dependent, that is objects 3 and 4. On deletion of either of these objects, the file storage software analyses the dependency list 6 and will activate the second auxiliary function in the JOIN class which, for example, may either automatically delete the object 5 or notify a user that an object upon which object 5 is dependent has been deleted.

Another contract is the “validate” contract. This is used in conjunction with the dependency tracking contract already described. It ensures that the user does not specify erroneous information, for example that the particular object depends on a non-existent object or on itself.

There is one auxiliary function associated with this contract that is operable to confirm the existence of objects which an object indicates that it depends upon and to confirm that the object does not refer to itself. If the auxiliary function returns a positive result then the data object is saved otherwise the user is notified of the discrepancy.

Another contract is the “identity” contract. This has two associated auxiliary functions. Objects implementing the contract execute the first whilst being stored and this assigns a unique identification code to the object which may be generated by the software or may be input by a user. The unique identification code may be stored in the object or in a separate list.

The second auxiliary function simply retrieves this unique identification code and presents it to a user on request.

An example is shown in FIG. 3, in which a table object 3 is being stored. As a result, the associated auxiliary function is executed which generates a unique identification number 7 and incorporates it in the stored object 3b.

A simple example of the use of the invention will now be described with reference to FIG. 4. In this, a join is created by a user in step 10 and stored on the file store 2 in step 11. During the storage the file storage software checks for contracts that are implemented by the object being stored, in this case a join object and determines that the object implements the dependency tracking contract in step 12. The dependencies are then retrieved from the object being stored in step 13 in the manner already described and used to update the dependencies indexed in step 14.

In step 15, a user deletes a table referred to by the join and, as a result, in step 16, the software checks to see if anything needs the table and determines that in this case the join depends on the table. In step 17, the join is loaded into the software and the auxiliary function associated with deletion of the dependent object is executed and as a result, the join deletes itself in step 18.

It is important to note that while the present invention has been described in a context of a fully functioning data processing system, those of ordinary skill in the art will appreciate that the processes of the present invention are capable of being distributed in the form of a computer readable medium of instructions and a variety of forms and that the present invention applies equally regardless of a particular type of signal bearing media actually used to carry out distribution. Examples of computer readable media include recordable-type media such as floppy disks, a hard disk drive, RAM and CD-ROMs as well as transmission-type media such as digital and analogue communications links.

1. A data storage method comprising receiving a store command issued by a user in respect of a data object, and in response:
a. ascertaining whether an auxiliary function is associated with the data object;
b. storing the data object; and
c. executing the auxiliary function ascertained in step (a) to be associated with the data object.

2. A method according to claim 1, wherein the auxiliary; function ascertains whether the data object is dependent upon one or more other already stored data objects and constructs a dependency list that indicates any such dependencies.

3. A method according to claim 1, wherein the auxiliary function ascertains establishes a unique identification code for the data object and stores this identification code either in the data object itself or in a separate identification code table.

4. A data storage method comprising receiving a store command issued by a user in respect of a data object, and in response:
a. ascertaining whether an auxiliary function is associated with the data object;
b. if the auxiliary function is not associated with the data object, storing the data object; otherwise
c. executing the auxiliary function ascertained in step (a) to be associated with the data object and then storing the data object dependent on a result generated by the auxiliary function.

5. A computer program comprising computer program code means adapted to perform the steps of claim 1 when said program is run on a computer.

6. A computer program comprising computer program code means adapted to perform the steps of claim 4 when said program is run on a computer.

7. A computer program product comprising program code means stored on a computer readable medium for performing the method of claim 1 when said program is run on a computer.

8. A computer program product comprising program code means stored on a computer readable medium for performing the method of claim 4 when said program is run on a computer.

9. A data storage system comprising a store for storing data objects and a controller adapted to perform the method of claim 1 and store the data objects in the store.

10. A data storage system comprising a store for storing data objects and a controller adapted to perform the method of claim 4 and store the data objects in the store.
